(19) United States
(12) Patent Application Publication
(10) Pub. No.: US 2012/0111697 A1
(43) Pub. Date: May 10, 2012

(54) STORAGE WAGON FOR TRANSPORTING BULK GOODS

(76) Inventors: Josef Theurer, Wien (AT); Manfred Brunninger, Altenberg (AT)

(21) Appl. No.: 13/378,292

(22) PCT Filed: Apr. 24, 2010
(86) PCT No.: PCT/EP10/02539

§ 371 Date: Jan. 5, 2012

(30) Foreign Application Priority Data
Jun. 17, 2009 (AT) GM 371/2009

(51) Int. Cl. B65G 15/26; B65G 37/00

(52) U.S. Cl. 198/594; 198/606

(57) ABSTRACT

A storage wagon (1) for transporting bulk material (2) is equipped with a bottom conveyor belt (4), extending in a longitudinal direction (5) of the wagon, which is arranged within a container (3) and serves as a bottom surface, and with a transfer conveyor belt (12) positioned at a front end (13) of the wagon and projecting beyond the same. At a rear end (29) of the wagon, a loading conveyor belt (17)—displaceable in the longitudinal direction of the wagon—as well as an excavating device (21) and a work cabin (20) are provided. A front end (25) of the loading conveyor belt (17) is mounted for displacement in the longitudinal direction (5) of the wagon by means of a drive (41) on a longitudinal guide (39) extending in an upper end region (16) of the container (3), thus forming a first belt support (28).

The invention relates to a storage wagon for transporting bulk material, comprising a bottom conveyor belt, extending in a longitudinal direction of the wagon, which is arranged within a container and serves as a bottom surface and has a receiving- and discharge end, and also comprising a transfer conveyor belt positioned at a front end of the wagon and projecting beyond the same, wherein a loading conveyor belt —displaceable in the longitudinal direction of the wagon—as well as an excavating device and a work cabin are provided at a rear end of the wagon.

A storage wagon of this type is known from WO 2007/116249 A3. The excavating device is fastened—together with a work cabin—directly to the wagon frame, with the loading conveyor belt being displaceable relative to the wagon frame into a working position. A structural solution of this kind allows only a limited width and length of the loading conveyor belt.

It is the object of the present invention to create a storage wagon of the type mentioned at the beginning which enables a more efficient loading operation to be carried out.

According to the invention, this object is achieved with a storage wagon of the specified kind in that a front end of the loading conveyor belt is mounted for displacement in the longitudinal direction of the wagon by means of a drive on a longitudinal guide extending in an upper end region of the container, thus forming a first belt support.

As a result of this structural solution, a very simple changeover between the working- and transfer position is ensured even in the case of a heavier embodiment of the loading conveyor belt for higher performance. In that way, the loading conveyor belt can be designed with greater width, thus being more efficient.

Additional advantages of the invention become apparent from the dependent claims and the drawing description.

The invention will be described in more detail below with reference to embodiments represented in the drawing in which

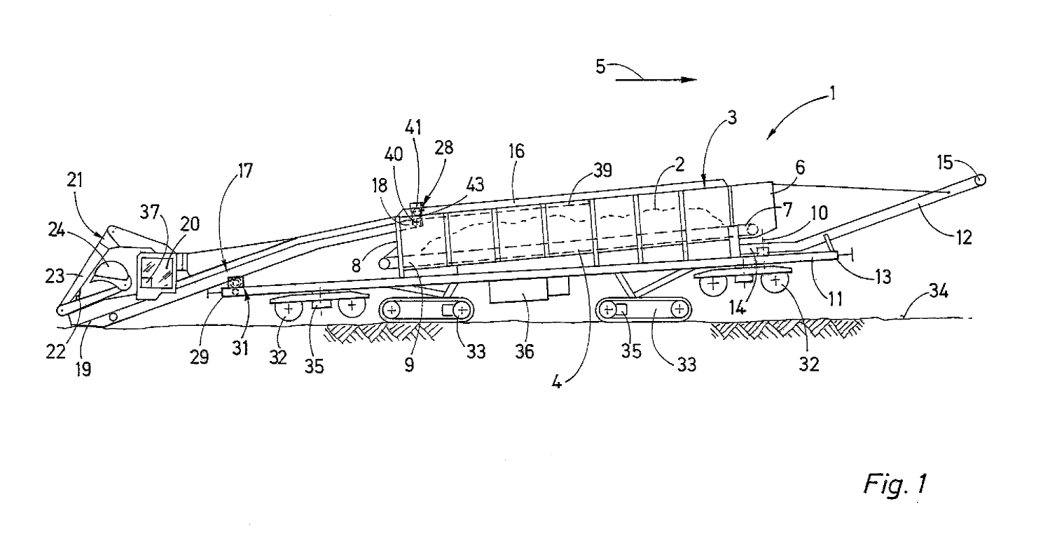

FIG. 1 shows a side view of a storage wagon having a loading conveyor belt,

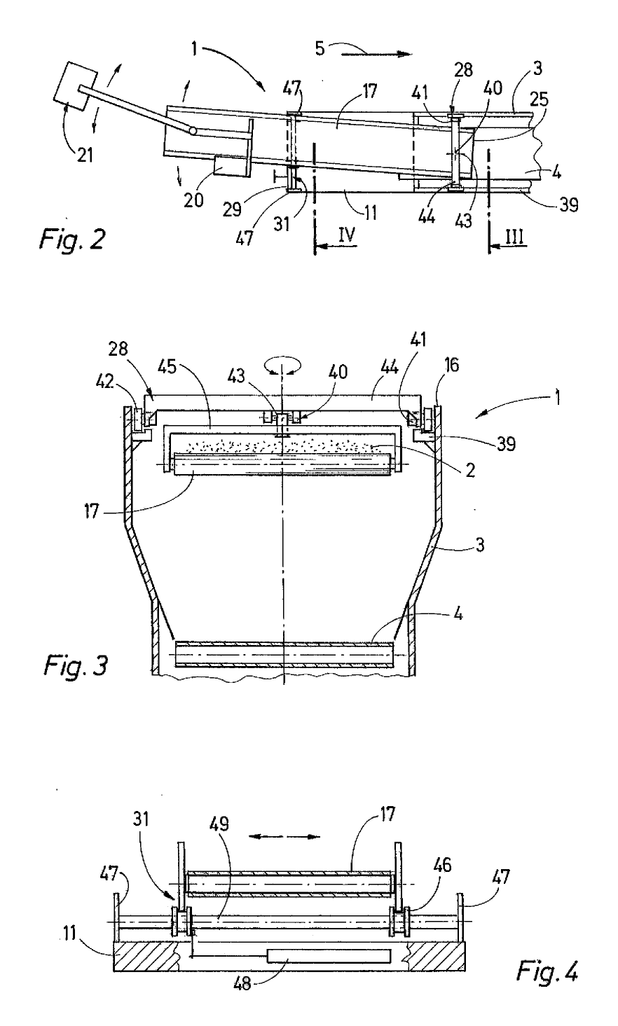

FIG. 2 shows a schematic top view of the loading conveyor belt, and

FIGS. 3 and 4 each show a view in the longitudinal direction of the wagon according to arrow Ill or IV in FIG. 2.

A storage wagon 1, visible in FIG. 1, for transporting bulk material 2 comprises a container 3 having a bottom conveyor belt 4 serving as a bottom surface. The bottom conveyor belt 4 has a discharge end 7, positioned at a front end 6 of the container 3 with regard to a longitudinal direction 5 of the wagon, and a receiving end 9 situated at a rear end 8 of the container 3.

Provided at a front end 13 of the wagon is a transfer conveyor belt 12 which is pivotable about an axis 10 and projects beyond a wagon frame 11. Said transfer conveyor belt 12 has a receiving end 14, situated underneath the discharge end 7 of the bottom conveyor belt 4, and a discharge end 15 positioned higher relative to the former.

Arranged in an upper end region 16 of the container 3 is a loading conveyor belt 17 extending in the longitudinal direction 5 of the wagon and having a front discharge end 18 and a rear receiving end 19. In a section immediately adjoining the receiving end 19, a work cabin 20 as well as an excavating device 21 is connected to the loading conveyor belt 17. The excavating device 21 is designed as an excavator jib 23 which is pivotable by means of drives 22 and changeable as to its length and has an excavator shovel 24.

As can be seen in FIGS. 2 and 3, the loading conveyor belt 17 has a front end 25, in the longitudinal direction 5 of the wagon, which rests on the container 3 in a first belt support 28. The latter is arranged in the upper end region 16 of the container 3 and has the shape of a linkage 40. The linkage 40 has a support beam 44, extending transversely to the longitudinal direction 5 of the wagon, which is mounted at the ends by means of track rollers 42 on a longitudinal guide 39 arranged on the container 3 and is displaceable by means of a drive 41 in the longitudinal direction 5 of the wagon. The drive 41 may be configured, for example, as a rotation drive acting upon the track rollers 42. The support beam 44 is connected by means of a universal joint 43 to a bracket-shaped suspension 45 which is mounted to the front end 25 of the loading conveyor belt 17 so as to leave sufficient free space for the transport of bulk material 2 on the conveyor belt 17.

At a rear end 29 of the wagon, a second belt support 31 is provided by means of which the loading conveyor belt 17 is mounted on the wagon frame 11 of the storage wagon 1—see FIG. 4. By means of support rollers 46, the loading conveyor belt 17 resting upon the same is configured to be displaceable in the longitudinal direction 5 of the wagon. The support rollers 46 are mounted on a transverse bar 49 for adjustment transversely to the longitudinal direction 5 of the wagon relative to the wagon frame 11, thus making the loading conveyor belt 17 transversely adjustable between two flanges 47 by means of a drive 48—as indicated also in FIG. 2. In this, the universal joint 43 functions as a pivot point.

The wagon frame 11 is mobile on a track or on a ballast bed or ground surface 34, as desired, by means of two on-track undercarriages 32 and two vertically adjustable crawler tracks 33. A motor 36 serves to actuate motive drives 35 as well as the various other drives. The work cabin 20, directly connected to the loading conveyor belt 17, is equipped with a control device 37 for actuation of various drives 22 of the excavating device 21.

The storage wagon 1 is driven on a track to a construction site—advantageously together with several storage wagons coupled to the front end of the wagon. During this, the loading conveyor belt 17 is in a transfer position (not shown) in which the entire loading conveyor belt 17 is situated above the wagon frame 11 or in the upper end region 16 of the container 3.

For the purpose of transferring the loading conveyor belt 17 into a working position, the drive 41 is actuated. The latter causes a longitudinal displacement of the loading conveyor belt 17, resting on the belt supports 28 and 31, relative to the storage wagon 1 into a position shown in FIG. 1, in which, on the one hand, the excavating device 21 and the work cabin 20 are located immediately above the ballast bed 34 and, on the other hand, the discharge end 18 is located above the receiving end 9 of the bottom conveyor belt 4. Thus, bulk material 2 taken up by the excavator shovel 24 can now be discharged onto the receiving end 19 and, in further sequence, via the discharge end 18 of the loading conveyor belt 17 onto the bottom conveyor belt 4. By corresponding transverse adjustment of the receiving end 19 by means of the drive 48, the receiving area of the excavating device 21 can be enlarged. Returning the loading conveyor belt 17 into the transfer position again is done by actuation of the drive 41 in the opposite direction.

1. A storage wagon for transporting bulk material, comprising a bottom conveyor belt (4), extending in a longitudinal direction (5) of the wagon, which is arranged within a container (3) and serves as a bottom surface and has a receiving- and discharge end (9, 7), and also comprising a transfer conveyor belt (12) positioned at a front end (13) of the wagon and projecting beyond the same, wherein a loading conveyor belt (17)—displaceable in the longitudinal direction of the wagon—as well as an excavating device (21) and a work cabin (20) are provided at a rear end (29) of the wagon, characterized in that a front end (25) of the loading conveyor belt (17) is mounted for displacement in the longitudinal direction (5) of the wagon by means of a drive (41) on a longitudinal guide (39) extending in an upper end region (16) of the container (3), thus forming a first belt support (28).

2. A storage wagon according to claim 1, characterized in that the first belt support (28) is formed by a linkage (40) comprising a support beam (44) designed to roll on the longitudinal guide (39) by means of track rollers (42) placed at the ends, the support beam (44) being connected to the end (25) of the loading conveyor belt (17) by means of a universal joint (43).
